(19) United States
(12) Patent Application Publication
(10) Pub. No.: US 2026/0119653 A1
(43) Pub. Date: Apr. 30, 2026

(54) SYSTEM AND METHOD OF BLOCKING MALICIOUS ACTIVITY OF LEGITIMATE DRIVERS

(71) Applicant: AO Kaspersky Lab, Moscow (RU)

(72) Inventors: Andrey L. Kirzhemanov, Moscow (RU); Yury G. Parshin, Moscow (RU); Yury V. Spravtsev, Moscow (RU)

(21) Appl. No.: 19/077,100

(22) Filed: Mar. 12, 2025

(30) Foreign Application Priority Data
Oct. 24, 2024 (RU) 2024131946

(51) Int. Cl. G06F 21/55; G06F 21/54

(52) U.S. Cl. CPC G06F 21/554; G06F 21/54; G06F 21/552

(57) ABSTRACT

Disclosed are systems and methods for blocking the malicious activity of legitimate drivers. An example method comprises collecting information about protected objects and information about drivers loaded in an operating system (OS) of a computer system; detecting at least one legitimate driver using information about the drivers loaded into the OS and malicious activity detection rules; intercepting an Import Address Table (IAT) call and/or an input/output control (IOCTL) system call made by at least one legitimate driver; determining if the intercepted call is directed to a protected object and triggers a malicious activity detection rule that requires blocking of the intercepted call; and blocking the intercepted call from detected legitimate drivers directed to the protected object based on the triggered malicious activity detection rule.

### CROSS REFERENCE TO RELATED APPLICATIONS

The present application claims benefit of priority to a Russian Application No. 2024131946 filed on Oct. 24, 2024, and which is incorporated by reference herein.

### FIELD OF TECHNOLOGY

The present invention relates to the field of information technology, and more specifically to systems and methods for blocking malicious activity of legitimate drivers.

### BACKGROUND

Malicious software is constantly evolving, prompting security service providers to keep up with the ever-changing threat landscape. In particular, attackers are developing ways to distribute malicious software and exploit new vulnerabilities to penetrate computer systems. There are many different types of attacks on computer systems. For example, an attack on a computer system using a rootkit driver. As an example of rootkit drivers, let's consider skyu24.sys and qz.sys that the Haxdoor rootkit installs and registers in the registry. These drivers intercept a certain kernel-mode functions, such as ZwCreateProcess, ZwCreateProcessEx, ZwOpenProcess, ZwOpenThread, ZwQueryDirectoryFile, ZwQuerySystemInformation and others. Using intercepted functions, rootkit drivers can modify system information, such as the list of processes and DLLs, monitor the opening and creation of processes, and perform other actions on the compromised computer system.

To counter rootkit drivers, Microsoft Corp. has introduced a driver signing requirement. This innovation allows only signed drivers, which are known not to be intended for attacking the computer system, to be loaded on the Windows operating system.

However, the attackers, in turn, invented the Bring Your Own Vulnerable Driver (BYOVD) attack method. According to this method, a legitimate driver that contains known vulnerabilities is used to carry out the attack. Because these drivers are signed, the operating system allows you to install and run them.

One of the options for combating this type of attack was used by Microsoft Corp. This option is to create a “black” list, which included legitimate drivers containing known vulnerabilities, and then prohibit the installation and launch of such drivers in the OS. The obvious disadvantage of this option is a complete ban on the execution of the functionality embedded in the driver, including those necessary for the operation of various devices, which in turn can negatively affect the operation of the entire operating system.

Thus, there is a need to create a solution that would eliminate this flaw and allow control over function calls of a legitimate driver and block only malicious activity of legitimate drivers in the operating system.

### SUMMARY

The task of the proposed solution is to monitor and control calls of legitimate drivers in order to detect malicious activity in the operating system (OS). One technical result is to increase the security of the OS. It is achieved with the help of a proposed solution designed to block the malicious activity of legitimate drivers.

In one example aspect, a method for blocking malicious activity of legitimate drivers comprises: collecting information about protected objects and information about drivers loaded in an OS of a computer system; detecting at least one legitimate driver using information about the drivers loaded into the OS and malicious activity detection rules; intercepting an Import Address Table (IAT) call and/or an input/output control (IOCTL) system call made by at least one legitimate driver; determining if the intercepted call is directed to a protected object and triggers a malicious activity detection rule that requires blocking of the intercepted call; and blocking the intercepted call from detected legitimate drivers directed to the protected object based on the triggered malicious activity detection rule.

In one aspect, the protected object is at least one of: OS kernel memory, namely loaded drivers, physical memory, processes, file objects, and/or registry objects.

In one aspect, the information on the protected objects comprises at least one of: page table for the “SYSTEM” process, file object path mask, path mask to registry objects, process ID, information about the base address of the process, and/or information about the amount of memory allocated to the process.

In one aspect, the information about the loaded drivers comprises at least one of: driver name, the path to the driver, driver load address, driver PE header fields, driver version, and/or the path to the driver symbol file.

In one aspect, the malicious activity detection rules are stored in a rules database included in the OS's system registry.

In one aspect, intercepting an IAT call includes: replacing the address of the analyzed function from the malicious activity detection rule with the address of the interceptor function.

In one aspect, intercepting an IOCTL system call includes splicing to the entry point of the detected legitimate driver.

In one aspect, intercepting an IOCTL system call includes: intercepting OS registry operations in the context of the “SYSTEM” process, detecting an operation with the RegNtPostQueryKeyName type, extracting the key from the registry path of the detected operation, retrieving a device object based on the extracted key, and/or accessing incoming IOCTL calls by intercepting the DriverInit function.

In one aspect, intercepting an IOCTL system call includes, retrieving an object of a legitimate driver by iterating over the services in the system registry and comparing the path to the legitimate driver with the ImagePath value of the said services.

In another example aspect, a system for blocking malicious activity of legitimate drivers, comprises a hardware processor operable to execute an OS, and further configured to: collect information about protected objects and information about drivers loaded in the OS; detect at least one legitimate driver using information about the drivers loaded into the OS and malicious activity detection rules; intercept an IAT call and/or an IOCTL system call made by at least one legitimate driver; determine if the intercepted call is directed to a protected object and triggers a malicious activity detection rule that requires blocking of the intercepted call; and block the intercepted call from detected legitimate drivers directed to the protected object based on the triggered malicious activity detection rule.

In yet another example aspect, a non-transitory computer readable medium storing thereon computer executable instructions for blocking malicious activity of legitimate drivers, including instructions for collecting information about protected objects and information about drivers loaded in an OS of a computer system; detecting at least one legitimate driver using information about the drivers loaded into the OS and malicious activity detection rules; intercepting an IAT call and/or an IOCTL system call made by at least one legitimate driver; determining if the intercepted call is directed to a protected object and triggers a malicious activity detection rule that requires blocking of the intercepted call; and blocking the intercepted call from detected legitimate drivers directed to the protected object based on the triggered malicious activity detection rule.

### BRIEF DESCRIPTION OF DRAWINGS

The accompanying drawings, which are incorporated into and constitute a part of this specification, illustrate one or more example aspects of the present disclosure and, together with the detailed description, serve to explain their principles and implementations.

FIG. 1 illustrates a diagram of a system for blocking malicious activity of legitimate drivers.

FIG. 2 illustrates an example of malicious activity detection rules based on IAT interception.

FIG. 3 illustrates an example of malicious activity detection rules based on IAT interception.

FIG. 4 illustrates an example of malicious activity detection rules based on IOCTL interception.

FIG. 5 illustrates a method for blocking malicious activity of legitimate drivers.

FIG. 6 illustrates an example of a computer system on which variant aspects of system and methods disclosed herein may be implemented.

### DETAILED DESCRIPTION

Exemplary aspects are described herein in the context of a system, method, and computer program product for blocking malicious activity of legitimate drivers. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

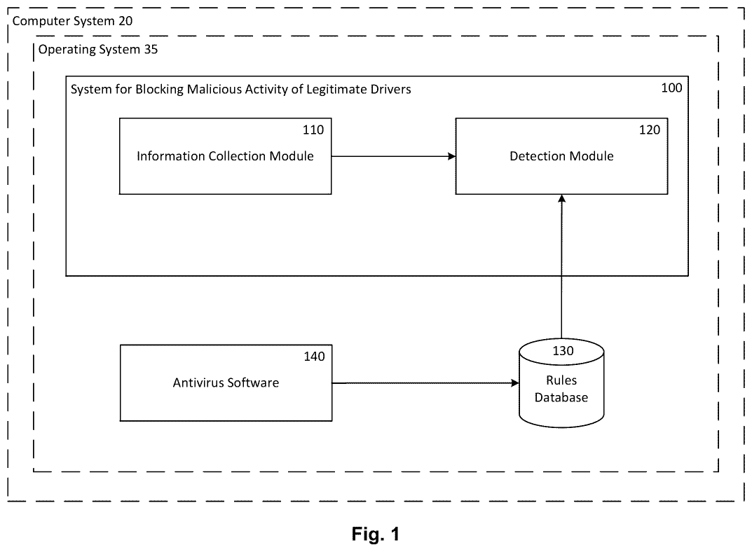

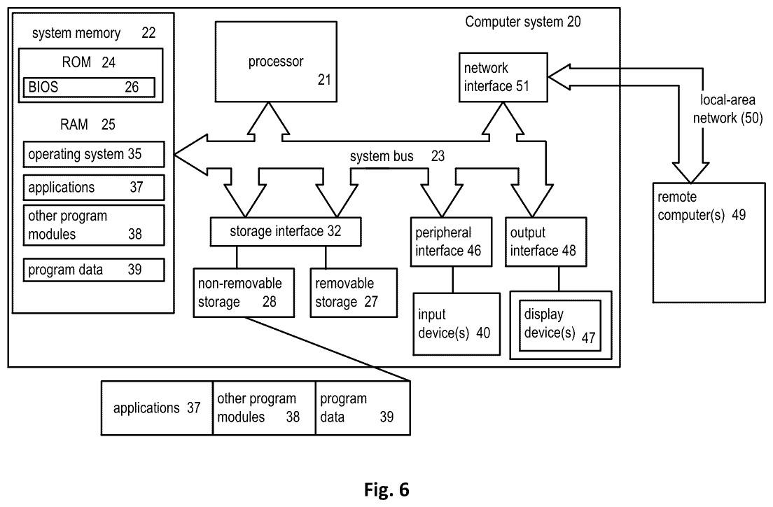

FIG. 1 illustrates a diagram of a system for blocking malicious activity of legitimate drivers 100 (hereinafter referred to as System 100). The system 100 can be deployed in an operating system (OS) 35 of the computer system 20, such as a computer system depicted in FIG. 6. A legitimate driver includes a driver that is not malicious, but may contain vulnerabilities exploited by attackers. Malicious activity refers to function calls aimed at disrupting the operability of predefined protected objects. Examples of violations of the operability of protected objects are: stopping a protected process or modifying a protected driver. Protected objects may include, but are not limited to:
drivers loaded into OS kernel memory, such as an antivirus software driver;
physical memory, such as the top-level page table for the “SYSTEM” process.
processes, such as antivirus software processes;
file objects, for example, file objects of anti-virus software located in the path “\\PROGRAMDATA\\KASPERSKY LAB\*”;
registry objects, such as antivirus software registry objects located in the path “*\\SYSTEM\\CURRENTCONTROLSET\\SERVICES\\KL*”.

In one example aspect, the system 100 comprises a information collection module 110, a detection module 120, and a rules database 130.

In one aspect, the rules database 130 may be part of the OS registry.

In one aspect, the system 100 may be implemented as at least one driver operating at the OS kernel mode. It is worth noting that the OS kernel mode belongs to the zero ring of protection (ring 0) according to the information security and functional fault tolerance architecture, which implements hardware separation of system and user privilege modes.

The information collection module 110 is designed to collect information about protected objects and to collect information about drivers loaded into the OS.

In one aspect, the information collection module 110 collects information about a protected object, such as a protected process, as follows: (1) Determines whether the protected process is running. (2) If the protected process is not running, it run the protected process. (3) Collects information about the protected process through the OS; and (4) If necessary, terminates the protected process, for example, if at the time of collecting the information there is no need for one of the processes of the antivirus software to work.

The information collected about each protected process includes, but is not limited to, base address information, information about the amount of memory allocated to the process, and identifier of the protected process (i.e. process ID).

The information collected about each driver loaded into the OS includes, but is not limited to, driver name, the path to the driver, the in-memory load address of the driver, and driver PE header fields, as well as path to the driver symbol file and/or driver version if available in the OS.

The information collection module 110 collects information about other protected objects from the OS, including, but not limited to, page table for the “SYSTEM” process, file object path mask, and path mask to registry objects.

Program Database (PDB) includes a program database file that contains debugging information for a compiled executable file.

Portable Executable (PE) is a format for executable files, object code, and dynamic libraries. The PE format is a data structure that contains all the information needed by the PE loader to map a file to memory.

The PE header contains the basic information about the file (driver) needed to load and execute it. The PE header includes:
MS-DOS Header—is a header that is compatible with MS-DOS and contains information about the old executable file format.
PE Signature—is a signature that identifies the file as PE format.
COFF File Header—is a COFF header that contains general information about the executable file, such as the type of machine, number of sections, creation time, etc.
Optional Header—is an additional header that contains information specific to Windows, such as the entry point address, code and data size, information about dynamic libraries, etc.

The information collection module 110 transmits the collected information about protected objects and information about drivers loaded into the OS to the detection module 120.

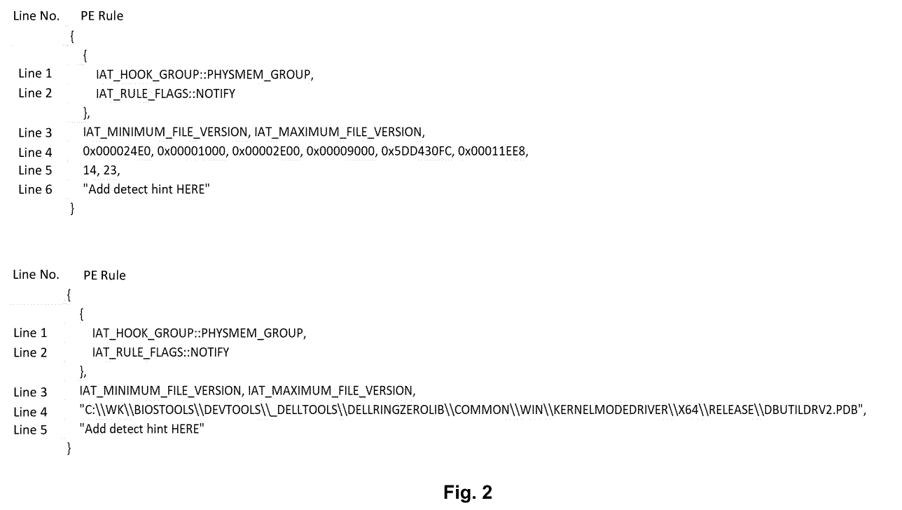

In one aspect, the detection module 120 is designed to retrieve malicious activity detection rules from the rules database 130, detect legitimate drivers loaded into the OS, intercept legitimate driver calls, detect malicious activity of legitimate drivers, and block the corresponding intercepted legitimate driver calls. Malicious activity detection rules allow detecting a legitimate driver, and in the event of detecting the malicious activity of a detected legitimate driver to take actions to neutralize it, for example, by blocking calls to functions related to malicious activity. Such rules allow blocking only a part of the calls of detected vulnerable legitimate drivers, so that the operability of the detected drivers and the OS as a whole is not disrupted. Examples of malicious activity detection rules are provided in the description of FIG. 2-FIG. 4. Malicious activity of legitimate drivers refers to calls directed to protected objects specified in the malicious activity detection rules. Thus, if a legitimate motherboard driver accesses an antivirus software process, for example, attempts to stop this process, this clearly indicates malicious activity of the specified driver.

The detection module 120 detects at least one legitimate driver through a malicious activity detection rule and intercepts calls from the detected driver. To detect a legitimate driver, the detection module 120 uses rules based on one of the following approaches: (1) detection of a legitimate driver based on PE headers (hereinafter referred to as the PE rule). The PE rule is designed to detect a legitimate driver based on the PE headers of driver files loaded into the OS. (2) Detection of a legitimate driver based on a PDB file (hereinafter referred to as the PDB rule). A PDB rule is designed to detect a legitimate driver based on driver PDB files loaded into the OS. In one aspect, any malicious activity detection rule contains either a PE rule or a PDB rule.

The detection module 120 intercepts function calls based on these rules, wherein each rule further contains information for using one of the two options described below for interception.

The first option (hereinafter referred to as IAT interception) is to use the Import Address Table (IAT), in which the detection module 120 replaces the address of the analyzed function from the malicious activity detection rule with the address of the interceptor function.

IAT is a table that stores the virtual addresses of functions imported from dynamic libraries. This table is used to map imported functions in memory when an executable file is run. The IAT contains information about the address of functions in dynamic libraries, which allows the program to call specified functions.

The second option (hereafter referred to as IOCTL interception) is to use the input/output control (IOCTL) system call. The IOCTL system call is a system call that allows you to manage devices and perform I/O operations that cannot be expressed by regular file operations. This call provides an interface for applications to interact directly with device drivers, perform various operations such as managing device parameters, retrieving device status information, formatting a disk, and so on.

To use IOCTL interception, the detection module 120 apply a splicing method to the entry point of the detected legitimate driver. Splicing is a method of intercepting API functions by modifying the code of the target function. Typically, the first few bytes of the function are changed. Instead, a transition to the desired function is inserted. To ensure that the operation is performed correctly, the detection module 120 must allow the code that has been modified as a result of the splicing to be executed. For that, the detection module 120 saves the replaced memory area, and after the interception function is processed, restores the modified function area and allows the original function to be fully executed.

In one aspect, in order to use IOCTL interception, the detection module 120 intercepts registry operations of the OS in the context of the “SYSTEM” process in order to subsequently identify the name of a legitimate driver. When an operation of type RegNtPostQueryKeyName is detected, the detection module 120 extracting the key from the registry path of the specified operation, and then retrieves a device object based on the extracted key. If the driver object is in an uninitialized state, the detection module 120 sets intercept of the DriverInit function, and after the registry interception is triggered, the detection module 120 will receive information about the driver object and therefore access incoming IOCTL calls.

A device object (DEVICE_OBJECT) is a data structure used by the OS to represent a device object. A device object can be represented as a logical, virtual, or physical device for which the driver handles I/O requests.

In yet another aspect, to use IOCTL interception, the detection module 120 retrieves the driver object through the driver's path. To do this, the detection module 120 iterates over the services in the registry, compares the driver's path to the service's ImagePath, and, if the driver's path matches the service's ImagePath value, retrieves a driver object through which the detection module 120 accesses incoming IOCTL calls.

To detect malicious activity of legitimate drivers based on IAT and IOCTL interceptions, the detection module 120 applies malicious activity detection rules to intercepted calls. If the intercepted call is directed to the protected object and the triggered malicious activity detection rule specifies call blocking, the detection module 120 blocks an intercepted call to ensure the security of the specified protected object. It should be noted that the detection module 120 determines the fact that an intercepted call is directed to the protected object on the basis of the information collected about the protected objects.

In one aspect, after detecting malicious activity of legitimate drivers aimed at protected processes, the detection module 120 always blocks the corresponding intercepted calls.

The antivirus software 140 operating in the OS at the user mode periodically updates the rules for detecting malicious activity in the rules database 130, for example, once a day. It is worth noting that the user mode refers to the third ring of protection (ring 3).

In one aspect, the antivirus software 140 installs system 100 into the OS of the computer system.

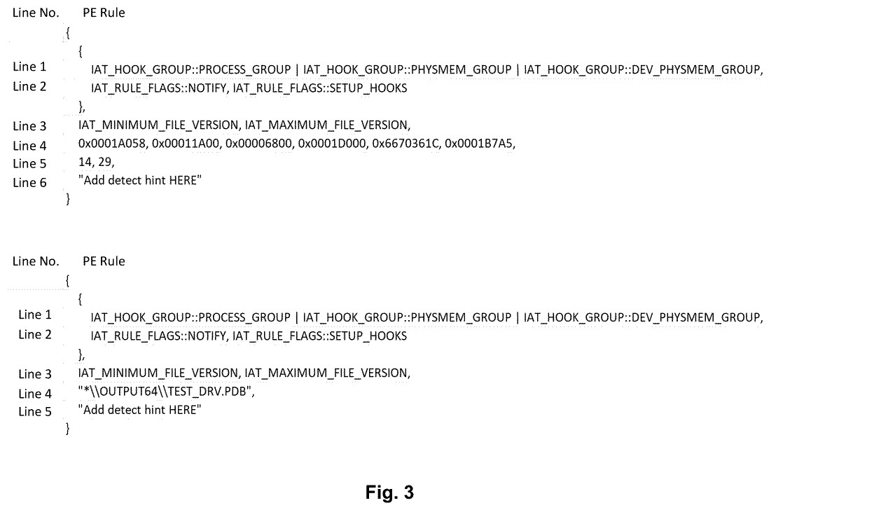

Examples of rules for detecting malicious activity based on IAT interception are shown in FIG. 2 and FIG. 3.

The first line of the PE rule is for specifying a group of interceptions. In this example, a group of PHYSMEM_GROUP is specified, which means that interception must be used to control operations (calls) over the protected physical memory.

It should be noted that in other examples of rules, instead of a PHYSMEM_GROUP group, you can specify such groups as: PROCESS_GROUP—control of operations (calls) with protected objects, DEV_PHYSMEM_GROUP—control of operations (calls) aimed at interacting with the \device\PhysicalMemory directory, and other groups. In this case, a malicious activity detection rule can contain references to one group or several groups.

The second line of the PE rule is intended for specifying flags. In the example under consideration, the NOTIFY flag is set. If the interception is triggered, the detection module 120 will receive a notification that the interception has been triggered. Otherwise, if the interception has not been triggered, the detection module 120 will receive a notification that the interception has not been triggered. The rule with the NOTIFY flag is useful for collecting statistics about the interception operation. Also, it is possible to set flag SETUP_HOOKS. If this flag is set and the interception is triggered, the detection module 120 will block the intercepted call. An example of a rule with the SETUP_HOOKS flag set is shown in FIG. 3.

The third line of the PE rule is intended to specify the lower and upper bounds of the legitimate driver's version.

The fourth line of the PE rule consists of the fields of the PE file: the offset to the entry point of the legitimate driver (entryPoint), the size of the initialized data (sizeOflnitedData), the size of the code (sizeOfCode), the size of the image (sizeOfImage), the timestamp and the checksum.

The fifth line of the PE rule consists of two fields of the PE file, namely the major (linkerMajor) and the minor (linkerMinor) versions of the linker.

The sixth line of the PE rule is intended for adding a comment that will be displayed in the notification.

The PDB rule for IAT interception is specified identically to the PE rule, but instead of the fourth and fifth lines, the path to the PDB file is specified. It is worth noting that both an absolute path (an example is shown in FIG. 2) and a path mask can be specified (an example is shown in FIG. 3)

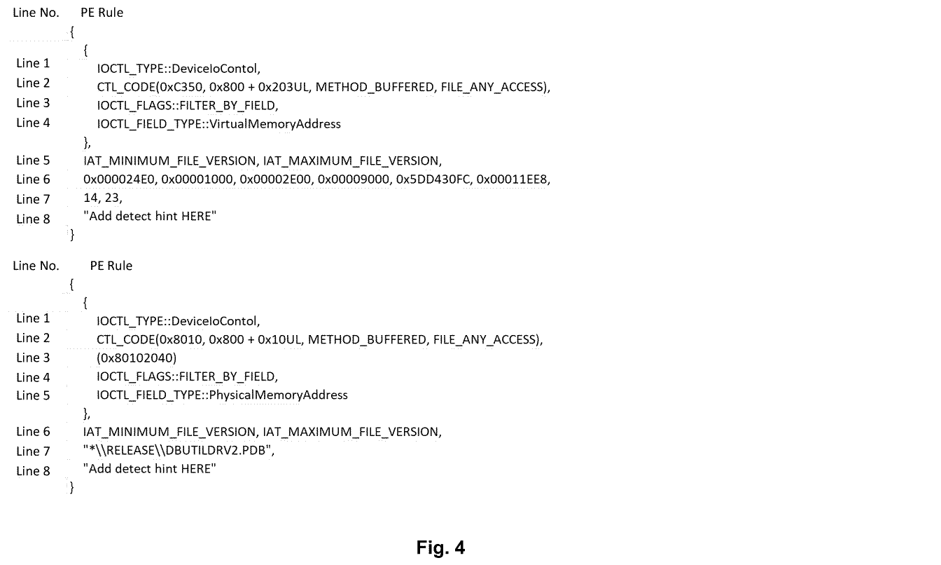

FIG. 4 is an example of malicious activity detection rules based on IOCTL interception. Starting with the line “IAT_MINIMUM_FILE_VERSION, IAT_MAXIMUM_FILE_VERSION”, the malicious activity detection rules presented in FIG. 4 are identical to the description in FIG. 2 and FIG. 3.

The first line of the PDB and PE rules indicates that this rule is intended to control the IOCTL of operations (calls).

The second line of the PDB and PE rules indicates the IOCTL value at which the call will be blocked.

In a PDB rule, the third line contains the size of the input buffer to check when the control flag EQUAL_INPUT_SIZE is set.

The fourth line in the PDB rule is identical to the third line in the PE rule and contains control flags. In this example, FILTER_BY_FIELD indicates that IOCTL will be monitored based on the input buffer. In addition to the above, control flags include DUMP_INPUT_BUFFER-saving the input buffer for a given IOCTL, DUMP_OUTPUT_BUFFER-saving the output buffer for a given IOCTL, BLOCK_ALWAYS-unconditional locking of a given IOCTL, EQUAL_INPUT_SIZE-validating the size of the input buffer.

The fifth line in the PDB rule is identical to the fourth line in the PE rule and indicates what the protection is aimed at based on this rule. In the example, PhysicalMemoryAddress is the protection of physical addresses in the OS.

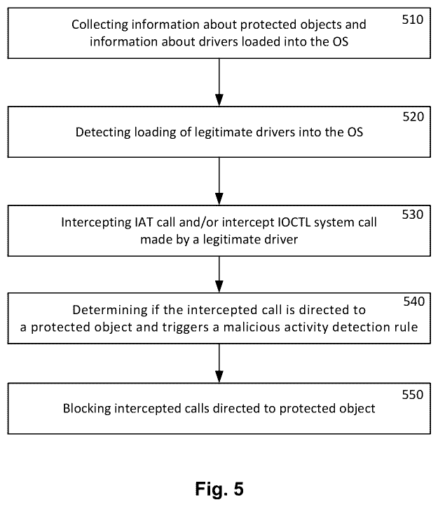

FIG. 5 illustrates a method for blocking malicious activity of legitimate drivers. In one aspect, the method may be performed using system 100 (see FIG. 1). The different steps of the method are described in more detail below.

In step 510, information about protected objects and information about drivers loaded into the OS is collected. Protected objects are defined as at least one of: OS kernel memory, namely loaded drivers; physical memory; processes; file objects; registry objects.

Information about all protected objects, except for processes, is collected through the OS. Information about protected processes is collected as follows: if the protected process is not running, the protected process is run; collect information about the protected process through the OS; if necessary, terminate the protected process, for example, if at the time of collecting the information there is no need for one of the processes of the antivirus software to work.

At step 520, at least one legitimate driver loaded into the OS is detected through information about the drivers loaded into the OS and malicious activity detection rules from the rules database 130.

At step 530, intercepting IAT call or IOCTL system call made by a legitimate driver.

At step 540, determining if the intercepted call is directed to a protected object and triggers a malicious activity detection rule that requires blocking of the intercepted call.

In step 550, intercepted calls from detected legitimate drivers directed to protected objects are blocked based on the information collected in step 510 about protected objects and malicious activity detection rules from the rules database 130.

FIG. 6 shows an example of a computer system 20 on which variant aspects of systems and methods disclosed herein may be implemented. The computer system 20 may represent the computer system 20 of FIG. 1 and can be in the form of multiple computing devices, or in the form of a single computing device, for example, a desktop computer, a notebook computer, a laptop computer, a mobile computing device, a smart phone, a tablet computer, a server, a cloud server, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, 12C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the OS with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 300.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 300 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for blocking malicious activity of legitimate drivers, comprises:
collecting information about protected objects and information about drivers loaded in an operating system (OS) of a computer system;
detecting at least one legitimate driver using information about the drivers loaded into the OS and malicious activity detection rules;
intercepting an Import Address Table (IAT) call and/or an input/output control (IOCTL) system call made by at least one legitimate driver;
determining if the intercepted call is directed to a protected object and triggers a malicious activity detection rule that requires blocking of the intercepted call; and
blocking the intercepted call from detected legitimate drivers directed to the protected object based on the triggered malicious activity detection rule.

2. The method of claim 1, wherein the protected object is at least one of: OS kernel memory, namely loaded drivers, physical memory, processes, file objects, and/or registry objects.

3. The method of claim 1, wherein the information about protected objects comprises at least one of: page table for the “SYSTEM” process, file object path mask, path mask to registry objects, process ID, information about the base address of the process, and/or information about the amount of memory allocated to the process.

4. The method of claim 1, wherein the information about the loaded drivers comprises at least one of: driver name, the path to the driver, driver load address, driver PE header fields, driver version, and/or the path to the driver symbol file.

5. The method of claim 1, wherein the malicious activity detection rules are stored in a rules database included in the OS's system registry.

6. The method of claim 1, wherein intercepting an IAT call includes: replacing the address of the analyzed function from the malicious activity detection rule with the address of the interceptor function.

7. The method of claim 1, wherein intercepting an IOCTL system call includes splicing to the entry point of the detected legitimate driver.

8. The method of claim 1, wherein intercepting an IOCTL system call includes:
intercepting OS registry operations in the context of the “SYSTEM” process,
detecting an operation with the RegNtPostQueryKeyName type,
extracting the key from the registry path of the detected operation,
retrieving a device object based on the extracted key, and/or
accessing incoming IOCTL calls by intercepting the DriverInit function.

9. The method of claim 1, wherein intercepting an IOCTL system call includes, retrieving an object of a legitimate driver by iterating over the services in the system registry and comparing the path to the legitimate driver with the ImagePath value of the said services.

10. A system for blocking malicious activity of legitimate drivers, comprises a hardware processor operable to execute an operating system (OS), and further configured to:
collect information about protected objects and information about drivers loaded in the OS;
detect at least one legitimate driver using information about the drivers loaded into the OS and malicious activity detection rules;
intercept an Import Address Table (IAT) call and/or an input/output control (IOCTL) system call made by at least one legitimate driver;
determine if the intercepted call is directed to a protected object and triggers a malicious activity detection rule that requires blocking of the intercepted call; and
block the intercepted call from detected legitimate drivers directed to the protected object based on the triggered malicious activity detection rule.

11. The system of claim 10, wherein the protected object is at least one of: OS kernel memory, namely loaded drivers, physical memory, processes, file objects, and/or registry objects.

12. The system of claim 10, wherein the information on the protected objects comprises at least one of: page table for the “SYSTEM” process, file object path mask, path mask to registry objects, process ID, information about the base address of the process, and/or information about the amount of memory allocated to the process.

13. The system of claim 10, wherein the information about the loaded drivers comprises at least one of: driver name, the path to the driver, driver load address, driver PE header fields, driver version, and/or the path to the driver symbol file.

14. The system of claim 10, wherein the malicious activity detection rules are stored in a rules database included in the OS's system registry.

15. The system of claim 10, wherein intercepting an IAT call includes: replacing the address of the analyzed function from the malicious activity detection rule with the address of the interceptor function.

16. The system of claim 10, wherein intercepting an IOCTL system call includes splicing to the entry point of the detected legitimate driver.

17. The system of claim 10, wherein intercepting an IOCTL system call includes:
intercepting OS registry operations in the context of the “SYSTEM” process,
detecting an operation with the RegNtPostQueryKeyName type,
extracting the key from the registry path of the detected operation,
retrieving a device object based on the extracted key, and/or
accessing incoming IOCTL calls by intercepting the DriverInit function.

18. The system of claim 10, wherein intercepting an IOCTL system call includes, retrieving an object of a legitimate driver by iterating over the services in the system registry and comparing the path to the legitimate driver with the ImagePath value of the said services.

19. A non-transitory computer readable medium storing thereon computer executable instructions for blocking malicious activity of legitimate drivers, including instructions for:
collecting information about protected objects and information drivers loaded in an operating system (OS) of a computer system;
detecting at least one legitimate driver using information about the drivers loaded into the OS and malicious activity detection rules;
intercepting an Import Address Table (IAT) call and/or an input/output control (IOCTL) system call made by at least one legitimate driver;
determining if the intercepted call is directed to a protected object and triggers a malicious activity detection rule that requires blocking of the intercepted call; and
blocking the intercepted call from detected legitimate drivers directed to the protected object based on the triggered malicious activity detection rule.

20. The non-transitory computer readable medium of claim 19, wherein the protected object is at least one of: OS kernel memory, namely loaded drivers, physical memory, processes, file objects, and/or register objects.
